(19) United States
(12) Patent Application Publication
(10) Pub. No.: US 2026/0200462 A1
(43) Pub. Date: Jul. 16, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/390,626

(22) Filed: Nov. 16, 2025

(30) Foreign Application Priority Data
Jan. 10, 2025 (JP) 2025-003953

(51) Int. Cl. B60W 30/06; B60W 50/02; G06Q 10/02

(52) U.S. Cl. CPC B60W 30/06; B60W 50/0205; G06Q 10/02; B60W 2530/20; B60W 2556/10

(57) ABSTRACT

The check-in processing of the relevant vehicle is performed before the execution of the entry processing for the relevant vehicle of the automated valet parking. In the check-in processing, sensor information is acquired from a sensor that detects the tire pressure of the relevant vehicle. In the check-in processing, when the sensor information indicates a sensor abnormality, removal of the sensor is estimated based on the internal history information of the relevant vehicle. In the check-in processing, when the removal of the sensor is estimated, it is determined whether or not the relief condition is satisfied based on the history information of the automated valet parking for the relevant vehicle. When it is determined that the relief condition is satisfied, execution of the entry processing is permitted.

### CROSS-REFERENCE TO RELATED APPLICATION

This application claims priority to Japanese Patent Application No. 2025-003953 filed on January 10, 2025. The disclosure of the above-identified application, including the specification, drawings, and claims, is incorporated by reference herein in its entirety.

### BACKGROUND

### 1. Technical Field

The present disclosure relates to automated valet parking (AVP: Automated Valet Parking) of vehicles within a predetermined area,such as a parking lot.

### 2. Description of Related Art

Japanese unexamined patent application publication no. 2021-84626 (jp 2021-84626 a) discloses technology related to avp. In this conventional technology, an infrastructure that supports avp inspects whether a sensor that is installed in a vehicle that has transmitted a parking request operates normally, and determines whether avp of the vehicle is enabled, based on results of the inspection. When a particular sensor is not installed in the vehicle, determination is made that avp of this vehicle is not enabled. Even when the particular sensor is installed in the vehicle, determination is made that avp of this vehicle is not enabled when operations of this particular sensor do not satisfy requirement conditions of the parking lot.

### SUMMARY

According to documents of the German Association of the Automotive Industry (VDA), an example of a starting condition for AVP that is listed is that tire pressure of a relevant vehicle for AVP is appropriate. The reason for this is that when the tire pressure is low, effects on loaded radius become great, and effects on vehicle control related to AVP also becomes great. In light of this background, it is desirable to obtain information on the tire pressure from the relevant vehicle for AVP and confirm that the tire pressure is appropriate when AVP is carried out, particularly when entry is carried out.

The tire pressure of the relevant vehicle for AVP can be acquired from sensor information of an in-vehicle air pressure sensor. However, when the tire is replaced and the air pressure sensor is removed, the sensor information of the air pressure sensor may indicate sensor abnormality. In this case, there is a possibility that determination will be made that entry of the relevant vehicle for AVP cannot be started, even though the actual tire pressure is appropriate. Accordingly, technological development for suppressing such trouble is desired.

It is an object of the present disclosure to provide technology for suppressing a situation in which entry of a relevant vehicle for AVP cannot be started when sensor information of an air pressure sensor indicates a sensor abnormality, caused by the air pressure sensor having been removed due to replacement of a tire, or the like.

A first aspect of the present disclosure is a system for performing automated valet parking of a vehicle in a predetermined area.

The system includes one or a plurality of storage devices and one or a plurality of processors. The one or multiple storage devices store history information of the automated valet parking.

The one or multiple processors perform check-in processing of a relevant vehicle for the automated valet parking, prior to executing entry processing of the relevant vehicle.

The check-in processing includes

acquiring sensor information from a sensor for detecting tire pressure of the relevant vehicle,

acquiring internal history information of the relevant vehicle when the sensor information indicates a sensor abnormality,

estimating removal of the sensor based on the internal history information,

determining, when removal of the sensor is estimated, whether a relief condition is satisfied, based on the history information of the automated valet parking for the relevant vehicle, and

permitting execution of the entry processing when determination is made that the relief condition is satisfied.

A second aspect of the present disclosure is a method of causing a computer to perform automated valet parking of a vehicle in a predetermined area.

The method includes performing check-in processing of a relevant vehicle prior to executing entry processing of the relevant vehicle for the automated valet parking.

The check-in processing includes

acquiring sensor information from a sensor for detecting tire pressure of the relevant vehicle,

acquiring internal history information of the relevant vehicle when the sensor information indicates a sensor abnormality,

estimating removal of the sensor based on the internal history information,

determining, when removal of the sensor is estimated, whether a relief condition is satisfied, based on history information of the automated valet parking for the relevant vehicle, and

permitting execution of the entry processing when determination is made that the relief condition is satisfied.

According to the present disclosure, when the sensor information from the sensor for detecting the tire pressure of the relevant vehicle for AVP indicates a sensor abnormality, whether the sensor has been removed is determined based on the internal history information of the relevant vehicle. When determination is made that the sensor has been removed, determination is made regarding whether the relief condition is satisfied, based on the history information of AVP regarding the relevant vehicle for AVP. When determination is made that the relief condition is satisfied, the entry processing is permitted to be executed for the relevant vehicle for AVP. Accordingly, a situation in which entry processing is not started for the relevant vehicle for AVP, when the sensor information indicates a sensor abnormality due to the sensor being removed along with replacement of a tire, can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of an automated valet parking system;

FIG. 2 is a diagram illustrating a configuration example of a vehicle system;

FIG. 3 is a sequential diagram illustrating the flow of a processing associated with automated valet parking; and

FIG. 4 is a flowchart illustrating an example computer processing particularly related to features of an embodiment.

### DETAILED DESCRIPTION OF EMBODIMENTS

Hereinafter, embodiments of the present disclosure will be described with reference to the drawings. In each figure, the same or corresponding parts are designated by the same reference signs to simplify or omit the description.

### 1.Overall system configuration example

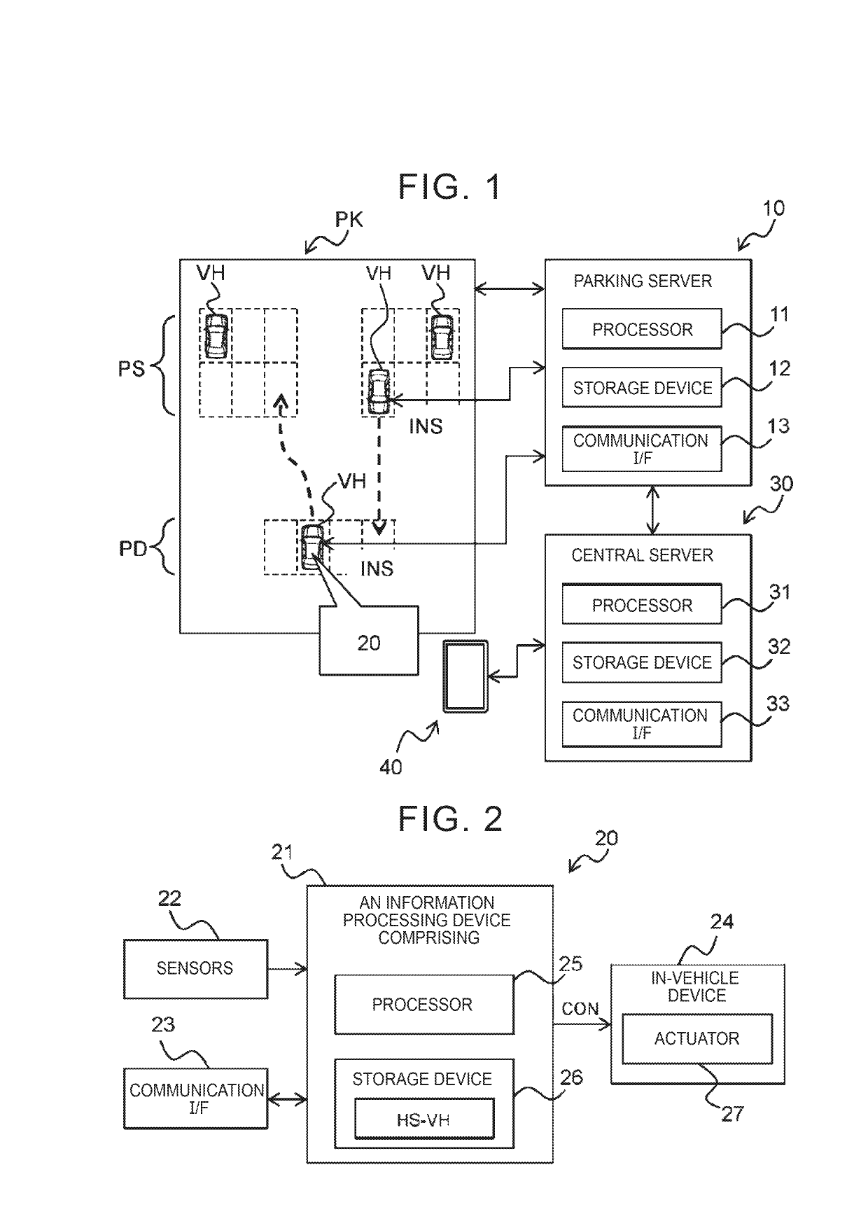

AVP system is a system that automatically performs a parking operation of vehicles in a predetermined area such as a parking lot, a factory, or a site of a facility. FIG. 1 is a diagram illustrating an exemplary configuration of a AVP system. FIG. 1 illustrates a parking lot PK as a predetermined area. The parking lot PK has a configuration capable of executing AVP. The configuration capable of executing AVP includes a getting-on/off space PD and a parking space PS.

The getting-on/off space PD is a space for getting off from the vehicle VH and/or getting on the vehicle VH. The parking space PS is a space for parking the vehicle VH. Configurations that can perform AVP also include markers that assist in moving vehicle VH within the parking lot PK, sensors that monitor vehicle VH (e.g., cameras, radars), and the like.

FIG. 1 also illustrates a server 10 that manages AVP in a parking lot PK (hereinafter, also referred to as a "parking lot server"). The parking lot servers 10 perform various processing related to managing the operating authority of the vehicle VH required for performing AVP missions (for example, entry missions, entry missions, and the like) in the parking lot PK. The parking lot servers 10 further acquire various types of information from the sensors of the parking lot PK, and perform various processing related to the execution of AVP missions based on the various types of information. The parking lot server 10 may be combined with a server (local server) that performs various processing related to the execution of AVP mission and a server (cloud server) that performs various processing related to the administration of AVP.

The parking lot server 10 is typically a computer including at least one processor 11, at least one storage device 12, and a communication I/F (interface) 13. The processor 11 executes various processing. Examples of the processor 11 include CPU (Central processing Unit), GPU (Graphics processing Unit), ASIC (Application Specific Integrated Circuit), FPGA (Field-Programmable Gate Array), and the like. The processor 11 may also be referred to as "circuitry" or "processing circuitry." A "circuitry" is hardware that is programmed to implement the described functions or hardware that performs the functions. The processor 11 reads various kinds of information from the storage device 12 and stores various kinds of information in the storage device 12.

Examples of the storage device 12 include volatile memory, non-volatile memory, HDD (Hard Disk Drive), SSD (Solid State Drive), and the like. Examples of the various types of information stored in the storage device 12 include parking lot map information, parking lot use information, and vehicle management information. The parking lot map information indicates map information of the parking lot PK. The parking lot use information is information related to the getting-on/off space PD in the parking lot PK and the use status (free information) of the parking space PS. The vehicle control information includes information such as a vehicle ID, an entry/exit history, and a vehicle position history. The vehicle management information is managed for each vehicle VH. The vehicle ID is the identity of the vehicle VH. The entry/exit history is information related to a history of entry/exit of the vehicle VH (for example, a reservation date, a reservation time, an actual date, an actual time, and the like). The entry/exit history corresponds to "history information of automated valet parking" of the present disclosure. The vehicle position history indicates the history of the position of the vehicle VH in the parking lot PK.

The communication I/F13 is an interface for communicating with an external device of the parking lot server 10 to transmit and receive data. For example, the communication I/F 13 includes a device for connecting to a surrounding device via a radio LAN, a device for connecting to a mobile communication network, a device for connecting to the Internet, and the like. The parking lot server 10 transmits and receives data to and from a vehicle VH (vehicle system 20) via a communication I/F 13. The parking lot server 10 also transmits and receives data to and from the central server 30 via a communication I/F 13.

FIG. 2 is a diagram illustrating a configuration example of the vehicle system 20. In the embodiment illustrated in FIG. 2, the vehicle system 20 is mounted on each of the vehicle VH as a system capable of executing AVP. In the embodiment illustrated in FIG. 2, the vehicle-system 20 includes an information processing device 21, sensors 22, a communication I/F 23, and an in-vehicle device 24.

The information processing device 21 is communicably connected to the sensors 22, the communication I/F 23, and the in-vehicle device 24. The information processing device 21 is a computer that performs information processing related to control of the vehicle VH based on various types of information. The information processing device 21 includes at least one processor 25 and at least one storage device 26. The configuration example of the processor 25 is the same as that of the processor 11 shown in FIG. 1. The configuration example of the storage device 26 is the same as that of the storage device 12 illustrated in FIG. 1. The processor 25 realizes information processing related to the control of the vehicle VH in cooperation with the storage device 26.

As the information specific to the present disclosure, the various kinds of information stored in the storage device 26 include the internal history information HS-VH of the vehicle VH. The internal history information HS-VH includes error (abnormality, failure) information about main equipment, auxiliary equipment, and various sensors of the vehicle VH. The error information includes, for example, an error code, an error occurrence date and time, a travel distance, an error occurrence condition, and the like. The error information of the various sensors includes the error information of the sensors attached to the main device, the auxiliary device, and the like, and the error information of the sensors 22.

For example, the information processing device 21 is configured by one or a plurality of ECU (Electronic Control Unit). In another embodiment, the information processing device 21 includes a kit (for example, a AVP kit) for the functions provided by the parking lot servers 10. The information processing device 21 generates and outputs a control signal of the vehicle VH by the information processing. When the vehicle VH receives AVP mission command INS from the parking lot server 10, the information processing device 21 generates a control signal CON for AVP mission. The control CON is transmitted to the in-vehicle device 24.

The sensors 22 detect environmental conditions and driving conditions of the vehicle VH. Examples of the sensors 22 include cameras, radars, LiDAR, wheel speed sensors, IMU (Inertial Measurement Unit), GNSS (Global Navigation Satellite System) sensors, and the like. Pneumatic sensors particularly related to the present disclosure are included in sensors 22. For example, the air pressure sensor detects the air pressure of the tires of the vehicle VH. The air pressure sensor is, for example, a device integrated with an air valve of a tire, and detects the air pressure and temperature of the tire and transmits the detected air pressure and temperature to the outside in real time. The information processing device 21 is included as a destination of detection information (sensor information) such as air pressure.

The communication I/F 23 is an interface for communicating with a device outside the vehicle VH to transmit and receive data. The vehicle VH transmits and receives data to and from the parking lot servers 10 via the communication I/F 23. The vehicle VH can also transmit and receive data to and from the user terminal 40 via a communication I/F 23.

The onboard device 24 includes lighting devices, onboard lighting devices, horns, wipers, doors, door windows, mirrors, drives, brakes, steering devices, HMI (Human Machine Interface), and the like. Each device of the in-vehicle device 24 includes an actuator 27 that can be controlled by the information processing device 21. The in-vehicle device 24 acquires a control signal from the information processing device 21. The operation of the actuator 27 in accordance with the control signal controls the in-vehicle device 24 by the information processing device 21. In addition, control of the vehicle VH is realized by control of the in-vehicle device 24. Vehicle control for AVP mission is realized by the actuator 27 operating in accordance with the control signal CON for AVP mission.

Returning to FIG. 1, a description of an overall configuration example will be continued. FIG. 1 also depicts a central server 30. The central server 30 is a server (cloud server) that manages the entire AVP service. The central server 30 may have some or all of the functions of the parking lot server 10. The central server 30 manages a user who uses AVP service (hereinafter, also referred to as "AVP user"), a vehicle having the vehicle system 20 (that is, a vehicle VH), and the like. Drivers of the vehicle VH are exemplary AVP users. The management of AVP user includes the authentication of AVP user, the management of AVP reservation by AVP user, and the like. The management of the vehicle VH includes management of the vehicle information of the vehicle VH, management of the operation authority of the vehicle VH, management of AVP operation log of the vehicle VH, and the like.

The central servers 30 are typically computers that include at least one processor 31, at least one storage device 32, and a communication I/F33. The processor 31 and the processor 11 of the parking lot server 10 are examples of "one or more processors" of the present disclosure. The storage device 32 and the storage device 12 of the parking lot server 10 are examples of "one or more storage devices" of the present disclosure. The configuration example of the processor 31 is the same as that of the processor 11. The configuration example of the storage device 32 is the same as that of the storage device 12.

Examples of the various types of information stored in the storage device 32 include AVP reservation information, user information, and AVP vehicle information. AVP reservation information is information related to the reservation of AVP by AVP user. AVP reservation information includes information such as a parking lot and a storage and retrieval time that AVP user desires to use. The user information includes information such as a vehicle ID of a vehicle used by a user ID, AVP user of AVP user. The user data is managed for AVP user. AVP vehicle information includes information such as the vehicle ID of the vehicle having the vehicle system 20, IP address of the vehicle system 20, and AVP operation log of the vehicle system 20.

The communication I/F33 is an interface for communicating with an external device of the central server 30 to transmit and receive data. For example, the communication I/F33 includes a device for connecting to a surrounding device via a radio LAN, a device for connecting to a mobile communication network, a device for connecting to the Internet, and the like. The central server 30 transmits and receives data to and from the parking lot server 10 via a communication I/F33. The central servers 30 also transmit and receive data to and from the user terminals 40 via a communication I/F33.

The user terminal 40 is, for example, a terminal carried by a AVP user (for example, a tablet/smart phone). The user terminal 40 may be a communication terminal (for example, an in-vehicle HMI) mounted on the vehicle VH. The user terminal 40 is an example of a "user terminal" of the present disclosure. The user terminal 40 includes at least one processor, at least one storage device, and a communication I/F. The configuration example of the processor of the user terminal 40 is the same as that of the processor 11. The configuration example of the storage device of the user terminal 40 is the same as that of the storage device 12. The user terminal 40 also includes a display for outputting various types of information.

AVP user transmits and receives data to and from the vehicle VH (vehicle system 20) by operating the user terminal 40. AVP user also transmits and receives data to and from the central servers 30 by operating the user terminals 40. The user terminal 40 is used for registering or reserving the use of AVP service by AVP user. The user terminal 40 is also appropriately used for AVP in the parking lot PK. Instead of the operation of the user terminal 40, the information regarding AVP may be transmitted and received by the operation of the in-vehicle device 24 (for example, HMI) illustrated in FIG. 2.

### 2.Sample processing associated with AVP

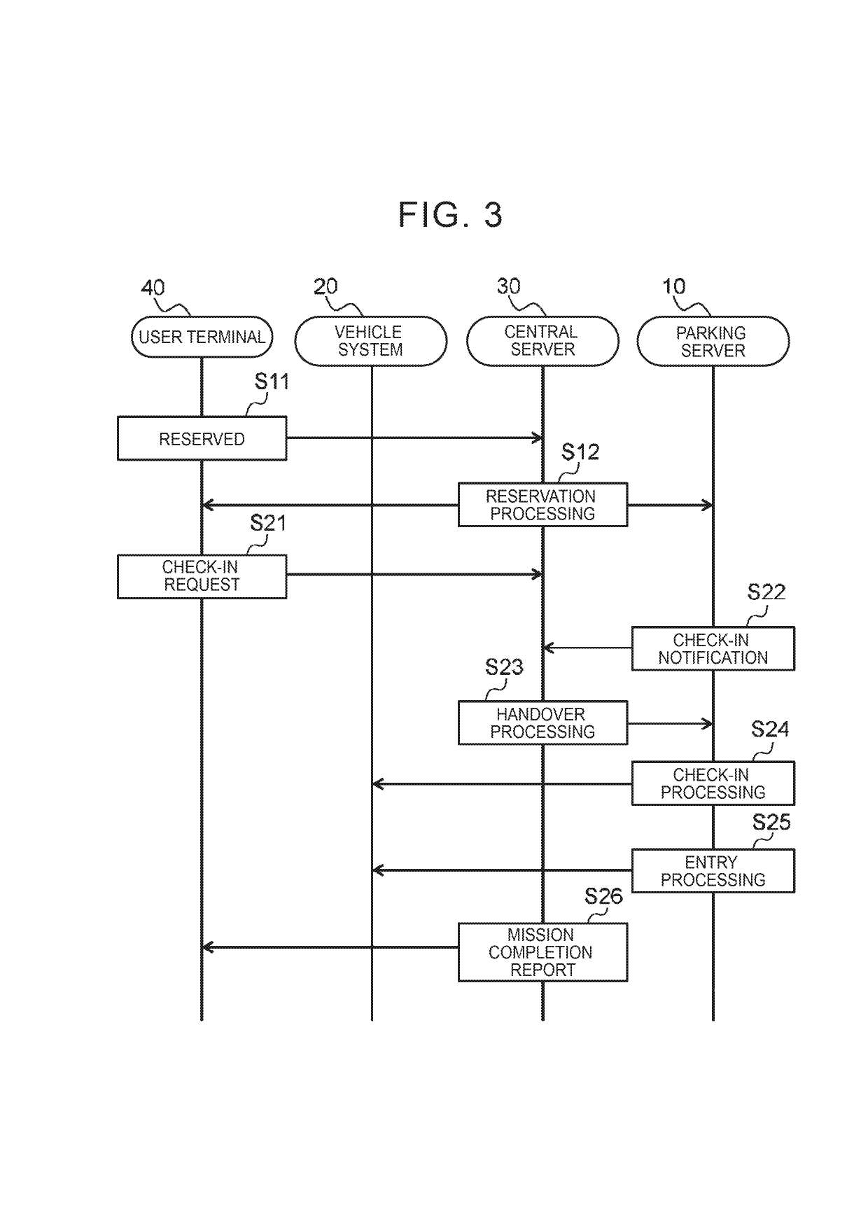

FIG. 3 is a sequence diagram illustrating a flow of a processing related to AVP. FIG. 3 shows the parking lot server 10, the vehicle system 20, the central server 30, and the user terminal 40 described with reference to FIGS. 1 and 2.

### 2-1. processing example related to reservation

In the embodiment illustrated in FIG. 3, first, S11 processing is performed. In S11 processing, the use of AVP service is reserved. The use reservation is made by transmitting AVP reservation information and the user information from the user terminal 40 to the central servers 30. Examples of AVP reservation information and examples of the user information are as described above.

Following S11, S12 is processinged. In S12 processing, AVP service-reserving processing is performed. The reservation processing is performed by the central server 30 that has received the information from the user terminal 40. In the reservation processing, for example, the reservation completion information is transmitted to the user terminal 40 that has transmitted AVP reservation information and the user information. Examples of the reservation completion information include a scheduled use date and time of the reservation ID, AVP service of AVP service, information of the parking lot PK to be reserved, and the like.

In the reservation processing, the parking lot servers 10 that manage the parking lot PK are specified based on the parking lot ID of the parking lot PK to be reserved included in AVP reservation data. Then, the scheduled usage date and time of AVP service included in AVP reservation information, the vehicle ID of the vehicle VH to be reserved, and the like are transmitted to the identified parking lot server 10. In the reservation processing, based on the vehicle ID of the reservation relevant vehicle VH included in AVP reservation information, IP address of the vehicle system 20 may be specified, and further, the specified IP address may be transmitted to the parking lot server 10 together with the vehicle ID.

The processing of S11 and S12 is related to AVP usage reservation. The processing of S36 from S21 to S27 and S31 is related to the actual use of AVP servicing. Note that the processing of S26 from S21 is a processing related to the entry of VH of vehicles to be reserved.

### 2-2. Examples of processing related to entry

In S21 processing, a check-in request for VH of vehicles to be reserved is made. The check-in request includes, for example, the above-described reservation completion information. The check-in request is transmitted from the user terminal 40 to the central server 30. The check-in request is transmitted by, for example, a AVP user who gets out of the reserved vehicle VH in the getting-on/off space PD operating the user terminal 40. When the check-in request is transmitted, a handover instruction is also transmitted. In the handover, the operating authority of VH of vehicles to be reserved is passed from AVP user to the parking lot servers 10.

In S22 processing, a check-in notification is performed. For example, the check-in notification is transmitted from the parking lot server 10 to the central server 30 when the parking lot server 10 recognizes VH of vehicles to be reserved that have entered the getting-on/off space PD. Note that S22 processing may be performed prior to S21 processing. That is, the central server 30 may receive the check-in notification from the parking lot server 10 before receiving the check-in request from the user terminal 40.

When both the handover instruction and the check-in notification are received by the central server 30, S23 processing is performed. In S23 processing, a handover processing is performed. In the handover processing, the operation authority of the vehicle VH to be reserved (hereinafter, also referred to as "reservation target TVH-RS") is passed from the central server 30 to the parking lot server 10. After the handover processing is performed, the operation authority moves to the parking lot server 10 until the handback processing to be described later is performed. Execution of AVP mission by the parking lot server 10 can be performed by temporary transfer of the operating authority.

Following S23 processing, S24 processing is performed. In S24 processing, a check-in processing is performed. In the check-in processing, the parking lot servers 10 that have been authorized to operate the reservation target TVH-RS communicate with the vehicle-system 20 of the reservation target TVH-RS. The parking lot server 10 activates the power supply of the vehicle system 20, checks the communication state with the vehicle system 20, and the like. In checking the communication status, for example, checking is performed by a surveillance camera of the responsive lighting in response to the lighting instruction of the lighting device of the reservation target TVH-RS. In the check-in processing, various kinds of information required for the entry processing, such as time synchronization and type information of TVH-RS to be reserved, are also obtained.

Following S24 processing, S25 processing is performed. In S25 processing, the entry processing is performed. The entry processing is processing for performing the entry mission, and is performed by the parking lot servers 10 having the operation authority of the reservation target TVH-RS (that is, the target of the entry mission). In the entry processing, for example, a traveling pass of a vehicle VH (hereinafter, also referred to as "entry target TVH-LD") subject to entry missions is set. The traveling path is a set of path points to be passed by the entry target TVH-LD from the current position of the entry target TVH-LD to the destination (for example, from the getting-on/off space PD to the parking space PS). The travel path is sequentially generated based on the parking lot map information stored in the storage device 12, for example.

In the entry processing, a command INS of the entry mission including at least the information of the traveling path is transmitted from the parking lot server 10 to the vehicle system 20 of the entry target TVH-LD. The vehicle system 20 (information processing device 21) of the entry target TVH-LD controls the in-vehicle device 24 of the entry target TVH-LD by generating a control-signal CON for the entry mission based on the command INS received from the parking lot server 10.

When the entry target TVH-LD arrives at the destination, S26 is processed. In S26 processing, a completion report of the entry mission is made. The completion report is performed, for example, as follows. That is, the parking lot server 10 that has confirmed that the entry target TVH-LD has arrived at the destination notifies the central server 30 of completion of the storage mission. The central server 30 that has received the completion notification reports the completion of the entry mission to the user terminal 40 that has transmitted the check-in request. In another embodiment, the central server 30 confirming the arrival of the entry target TVH-LD at the destination on the basis of the storage state reports the completion of the storage mission to the user terminal 40 that has transmitted the check-in request.

### 3.Features of the embodiments

As described above, it is desirable to obtain information on the tire pressure from the relevant vehicles of AVP and confirm that the tire pressure is appropriate when performing the entry. Therefore, in the embodiment, at the time of the check-in processing, it is confirmed that the tire pressure of the reservation target TVH-RS is appropriate on the basis of various kinds of information obtained from the reservation target TVH-RS (information for detecting the air pressure of the respective tires).

However, when the tire is replaced and the air pressure sensor is removed from the reservation target TVH-RS, it may be determined that the tire pressure is not appropriate because the sensor data of the air pressure sensor indicates a sensor error. Then, despite the fact that the actual tire pressure is appropriate, the processing cannot proceed to the entry processing of TVH-RS to be reserved. On the other hand, it is not desirable to proceed to the entry processing of the reserved TVH-RS when the tire pressure is not appropriate.

Therefore, in the check-in processing of the embodiment, when the detected information of the air pressure of the respective tires of the reservation target TVH-RS indicates a sensor error, the removal of the air pressure sensor is estimated by referring to the internal history information HS-VH of the reservation target TVH-RS. Further, when the removal of the air pressure sensor is estimated, it is determined whether or not the relief condition for the current entry processing is satisfied by referring to the entry/retrieval history of the reservation target TVH-RS. When it is determined that the relief condition is satisfied, the execution of the current entry processing is permitted.

As described above, the internal history information HS-VH includes error (abnormality, failure) information about various sensors of the vehicle VH. Therefore, in a case where the pneumatic sensor is removed due to the tire replacement, error information of the pneumatic sensor is generated and recorded in the storage device 26. Therefore, referring to the internal history information HS-VH, it is possible to estimate the removal of the air pressure sensor based on the error information of the air pressure sensor. In a case where the information on the tire replacement is recorded in the storage device 26, the removal of the air pressure sensor may be estimated based on the information.

As the relief condition, it is exemplified that the entry processing of the reservation target TVH-RS is permitted to be executed for a predetermined number of times (for example, several times) in the past from the current check-in processing of the reservation target TVH-RS. Another example of the relief condition is that the entry processing of the reservation target TVH-RS is permitted to be executed for a predetermined period (for example, several hours to several weeks) in the past from the current check-in processing of the reservation target TVH-RS. In this case of relief condition, the entry processing of the reserved TVH-RS can be performed in a case where a reason why the detected tire pressure indicates a sensor error is that the air pressure sensor is removed.

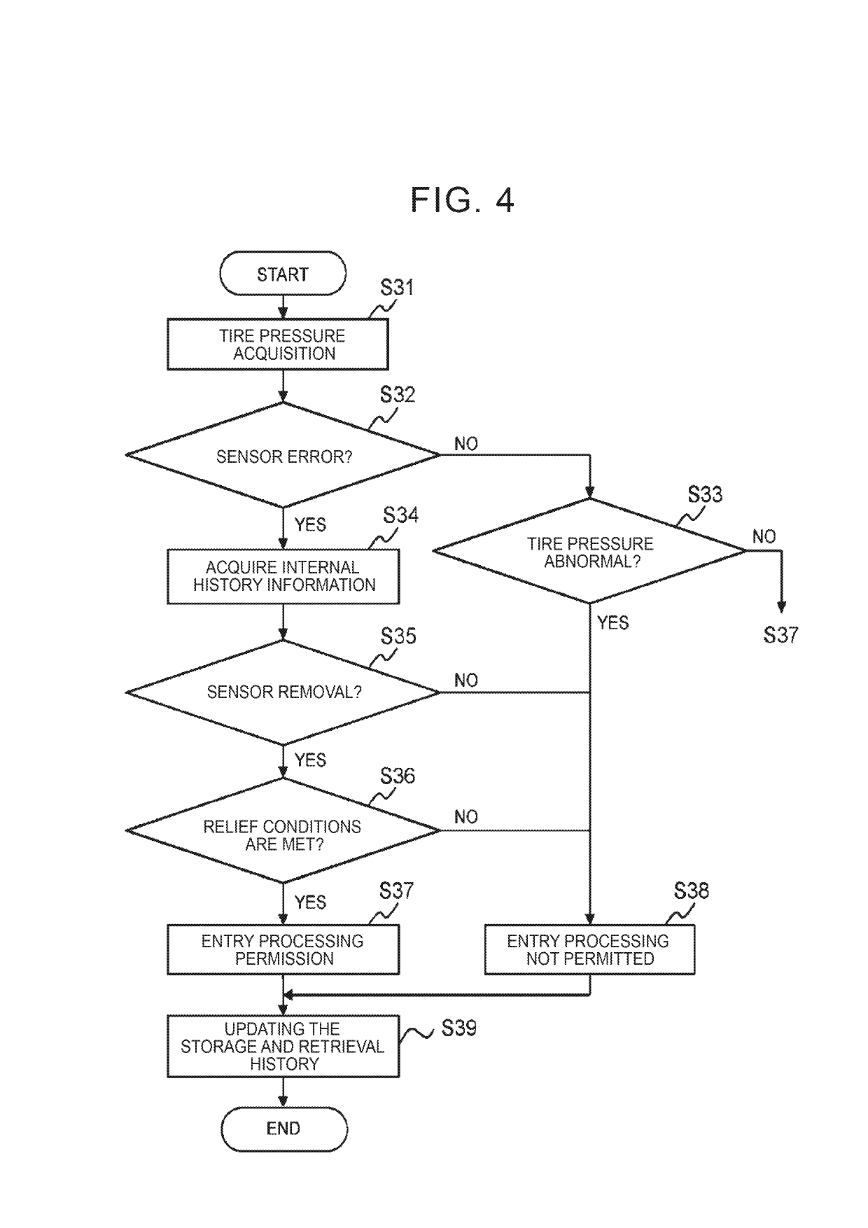

FIG. 4 is a flowchart illustrating an example computer processing particularly related to features of an embodiment. The routine illustrated in FIG. 4 is executed by the parking lot server 10 (processor 11) illustrated in FIG. 1. The routine illustrated in FIG. 4 is started as part of a check-in processing by the parking lot server 10, for example.

In the embodiment illustrated in FIG. 4, first, in S31 processing, the detected air pressure of the respective tires of the vehicle VH (reservation target TVH-RS) is acquired. The detected information of the air pressure of the tires is included in various kinds of information required for the entry processing of the vehicle VH (reservation target TVH-RS), and is acquired from the vehicle system 20 of the vehicle VH (reservation target TVH-RS).

Following S31 processing, S32 processing is performed. In S32 processing, it is determined whether or not the detected air pressure acquired by S31 indicates a sensor error. If S32 determination is negative, the processing proceeds to S33. If S32 determination is affirmative, the processing proceeds to S34.

In S33 processing, it is determined whether or not there is an abnormal tire pressure based on the detected air pressure acquired by S31. This determination is made for each tire. Whether or not there is an abnormality in the tire pressure is performed, for example, by comparing the tire pressure with a prescribed value. As the specified value here, the lower limit of the appropriate range of the tire pressure set for each vehicle type is exemplified. If the tire pressure falls below the lower limit of the proper range, it is determined that there is an abnormality in the tire pressure. If S33 determination is negative, the processing proceeds to S37. If S33 determination is affirmative, the processing proceeds to S38.

In S34 processing, the internal history information HS-VH of the vehicle VH (reservation target TVH-RS) is acquired. The detected information of the air pressure of the tires is included in various kinds of information required for the entry processing of the vehicle VH (reservation target TVH-RS), and is acquired from the vehicle system 20 of the vehicle VH (reservation target TVH-RS).

Following S34 processing, S35 processing is performed. In S35 processing, it is determined whether or not the air pressure sensor has been removed based on the internal history information HS-VH acquired by S34. Specifically, it is determined whether or not error information of the air pressure sensor is included in the internal history information HS-VH. The fact that the error information of the air pressure sensor is included in the internal history information HS-VH indicates that there is a possibility that the air pressure sensor was removed with the replacement of the tyre. Therefore, in the processing of step 35, the removal of the air pressure sensor is estimated based on the presence or absence of the error information. If S35 determination is affirmative, the processing proceeds to S36. If S35 determination is negative, the processing proceeds to S38.

In S36 processing, it is determined whether or not the relief condition is satisfied. As described above, as the relief condition, it is exemplified that the entry processing of the vehicle VH (the reservation target TVH-RS) is permitted to be executed a predetermined number of times or over a predetermined period of time in the past from the current check-in processing of the vehicle VH (the reservation target TVH-RS). In order to determine the relief condition, the entry/exit history of the vehicle VH (reservation target TVH-RS) stored in the storage device 12 is used. In S36 processing, specifically, it is determined whether or not the relief condition is satisfied by checking relief condition the entry/exit history a predetermined number of times or over a predetermined period in the past based on the date and time of the current check-in processing. If S36 determination is affirmative, the processing proceeds to S37. If S63 determination is negative, the processing proceeds to S38.

In S37 processing, the execution of the entry processing of the vehicle VH (reservation target TVH-RS) is permitted. On the other hand, in the processing of step 38, the execution of the entry processing of the vehicle VH (reservation target TVH-RS) is not permitted.

processing of S37 or S38 is followed by processing of S39. In S39 processing, the entry/exit history of the vehicle VH (reservation target TVH-RS) is updated. For example, in a case where S37 processing is performed through S33 processing (that is, in a case where the entry processing is permitted), the entry result data of the vehicle VH (the reservation target TVH-RS) is updated. When S37 processing is performed through S36 processing, information on the cumulative number of times that the relief condition is applied may be added to the entry result information. When S38 processing is performed (that is, when the entry processing is not permitted), the entry record data of the vehicle VH (reservation target TVH-RS) is updated. In this case, for example, the information indicating the reason why the entry processing is not permitted (tire pressure abnormality) is set as the entry result information.

In the above-described embodiment, the internal history information HS-VH is acquired during the check-in processing. However, the acquiring of the internal history information HS-VH may be performed at a stage of the reservation processing prior to the check-in processing. In this case, it is possible to efficiently determine the relief condition at the time of the check-in processing. However, as described with reference to FIG. 3, the reservation processing is performed between the central server 30 and the user terminal 40. Therefore, when the internal history information HS-VH is acquired at the time of the reservation processing, the internal history information HS-VH is sent to the parking lot server 10 through the user terminal 40 and the central server 30.

What is claimed is:

1. A system for performing automated valet parking of a vehicle in a predetermined area, the system comprising:
one or a plurality of storage devices in which history information of the automated valet parking is stored; and
one or a plurality of processors that perform check-in processing of a relevant vehicle for the automated valet parking, prior to executing entry processing of the relevant vehicle, wherein
the check-in processing includes
acquiring sensor information from a sensor for detecting tire pressure of the relevant vehicle,
acquiring internal history information of the relevant vehicle when the sensor information indicates a sensor abnormality,
estimating removal of the sensor based on the internal history information,
determining, when removal of the sensor is estimated, whether a relief condition is satisfied, based on the history information of the automated valet parking for the relevant vehicle, and
permitting execution of the entry processing when determination is made that the relief condition is satisfied.

2. The system according to claim 1, wherein the relief condition includes that execution of the entry processing for the relevant vehicle was permitted a predetermined count of times or a predetermined period of time in past from execution of the check-in processing of the relevant vehicle.

3. The system according to claim 1, wherein the one or multiple processors acquire the internal history information from the relevant vehicle when the check-in processing is executed.

4. The system according to claim 1, wherein the one or multiple processors acquire the internal history information from a user terminal of the relevant vehicle when executing reservation processing for the automated valet parking of the relevant vehicle.

5. A method for causing a computer to perform automated valet parking of a vehicle in a predetermined area, the method comprising:
performing check-in processing of a relevant vehicle prior to executing entry processing of the relevant vehicle for the automated valet parking, wherein
the check-in processing includes
acquiring sensor information from a sensor for detecting tire pressure of the relevant vehicle,
acquiring internal history information of the relevant vehicle when the sensor information indicates a sensor abnormality,
estimating removal of the sensor based on the internal history information,
determining, when removal of the sensor is estimated, whether a relief condition is satisfied, based on history information of the automated valet parking for the relevant vehicle, and
permitting execution of the entry processing when determination is made that the relief condition is satisfied.
